(19) United States
(12) Patent Application Publication
(10) Pub. No.: US 2009/0313703 A1
(43) Pub. Date: Dec. 17, 2009

(54) File-Based Chat System And Method

(75) Inventor: Andrew Mao, Plano, TX (US)

Correspondence Address: BAKER BOTTS L.L.P., 2001 ROSS AVENUE, SUITE 600, DALLAS, TX, 75201-2980, US

(73) Assignee: Fujitsu Network Communications, Inc., Richardson, TX (US)

(21) Appl. No.: 12/140,370

(22) Filed: Jun. 17, 2008

(51) Int. Cl. G06F 21/00; G06F 15/16; H04L 9/32

(52) U.S. Cl. 726/27; 709/206

(57) ABSTRACT

A method for computer-based chat includes coupling a plurality of clients to at least one chat file residing in a file system. The method also includes appending a first text from at least one of the plurality of clients to the at least one chat file. In addition, the method includes updating the plurality of clients with changes made to the at least one chat file.

### TECHNICAL FIELD

This invention relates generally to the field of communications and more specifically to file-based chat communication systems and methods.

### BACKGROUND

In collaborative efforts, communication is crucial to the success of a team. Further, a variety of types of communication have become commonplace and extremely useful. Rapid forms of communication help a project to move along quickly as members of the team do not need to wait long periods of time for responses from other team members.

A possible solution to this communication need is to deploy a traditional chat service. In this solution, a chat program is configured on a server. Each member of the team that would like to communicate has a chat client which connects to the chat program on the server. Once connected, the chat client can join virtual chat rooms which have been configured by the chat program on the server. However, this solution requires significant resources to setup and maintain. The server would have to be configured to allow for communications on the port which the chat program uses. This may involve opening a new port on the server, which increases security risks. Many existing networks have strict, complex policies as to which ports are available for communication. Introducing the need for opening a new port may require a restructuring of the policy which may be difficult to implement, especially in large networks. Further, organizing this chat program around the workflow of a particular team can be a significant undertaking. A custom set of virtual chat rooms would have to be configured for each team who had a slightly different workflow. In large organizations, configuring and maintaining these custom sets of virtual chat rooms may cost an enormous amount of time and resources. An alternative solution involves not organizing the chat program around the workflow of teams, but this may cause inefficiencies which may make the team less productive.

### SUMMARY

According to one embodiment, a method for computer-based chat includes coupling a plurality of clients to at least one chat file residing in a file system. The method also includes appending a first text from at least one of the plurality of clients to the at least one chat file. In addition, the method includes updating the plurality of clients with changes made to the at least one chat file.

The method may include appending a second text from a first client of the plurality of clients to the at least one chat file, wherein the second text is designated only for a second client of the plurality of clients. The method may further include updating only the first and second clients as a result of appending the second text to the at least one chat file. In addition, the at least one chat file may be a plain text file. The method may further include creating a user file associated with a client when a client is coupled to the at least one chat file to indicate presence.

According to one embodiment, a system for computer-based chat includes a first interface of a first client of a plurality of clients. The first interface is operable to couple the first client to at least one chat file residing in a file system. The system also includes a first processor of the first client which is coupled to the first interface. The first processor is operable to append a first text from the first client to the at least one chat file. The first processor is also operable to update a first display of the first client with changes made to the at least one chat file.

Depending on the specific features implemented, particular embodiments may exhibit some, none, or all of the following technical advantages. In one embodiment, chats may be easily organized around an existing workflow by placing chat files in an implemented directory structure. In other embodiments, chat files may be easily accessed by a variety of platforms because access to the chat file is controlled by the native file permissions of the file system. In still other embodiments, chats may be easily created in case of a malfunctioning component in a network since clients may create chat files in any location where other clients may access, including the device on which the client itself runs. Other technical advantages will be readily apparent to one skilled in the art from the following figures, description and claims.

### BRIEF DESCRIPTION OF THE DRAWINGS

Reference is now made to the following description taken in conjunction with the accompanying drawings, wherein like reference numbers represent like parts and which:

FIG. 1 illustrates one embodiment of a network in a file-based chat system;

FIG. 2 illustrates a screenshot of a client displaying the content of a chat and a chat file in accordance with a particular embodiment;

FIG. 3 illustrates one embodiment of an update file;

FIG. 4 is a flowchart describing one embodiment of the manner by which a client may write to a chat file;

FIG. 5 is a flowchart describing one embodiment of the manner by which a client may update its display;

FIGS. 6A, 6B, and 6C illustrate screenshots depicting the manner by which a user may join a chat in accordance with a particular embodiment;

FIG. 7 is a flowchart describing one embodiment of the manner by which a user may join a chat;

FIG. 8A is a flowchart describing one embodiment the manner by which a user may leave a chat;

FIGS. 8B and 8C illustrate screenshots depicting the manner by which a user may leave a chat in accordance with a particular embodiment;

FIG. 9 is a flowchart describing one embodiment of the manner by which a user sends a private message to another user in the chat;

FIG. 10 illustrates a screenshot depicting the manner by which one user in the chat sends a private message to another user in the chat in accordance with a particular embodiment; and

FIG. 11 illustrates a directory structure throughout which chat files may be dispersed in accordance with a particular embodiment.

### DETAILED DESCRIPTION

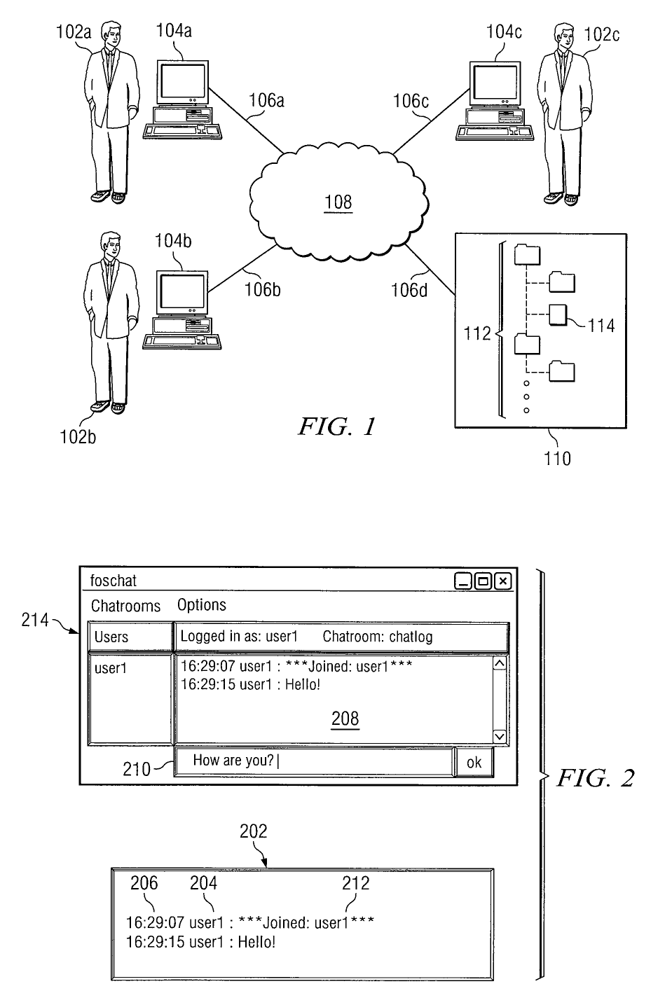

FIG. 1 illustrates one embodiment of a file-based chat system. Users 102a-c are associated with clients 104a-c and are connected to network 108 via connections 106a-c. Server 110 is connected to network 108 via connection 106d. Server 110 comprises file system 112. File system 112 comprises chat file 114. Users 102a-c communicate with each other by instructing clients 104a-c to append messages to chat file 114. Clients 104a-c also monitor chat file 114 and update their associated users 102a-c with changes to chat file 114. This process is described in further detail below.

As an example only, consider a situation in which three users 102a-c would like to communicate but are in remote locations. User 102a is at his residence; user 102b is at her place of business; user 102c is sitting at an airport. User 102a connects to server 110 using client 104a which, in this example, is his personal computer. User 102b uses a laptop computer, in this example, as her client 104b to connect to server 110. User 102c, located at an airport, uses a personal digital assistant (PDA), in this example, as her client 104c to connect to server 110. User 102a connects to network 108, which, in this example, is the Internet via connection 106a. In this example, connection 106a uses an Ethernet connection. User 102b connects to network 108 via connection 106b, which is also an Ethernet connection in this example, while user 102c connects to network 108 via connection 106c, a wireless data provider in this example. Server 110, in this example, is a computer-based server which has file system 112. In addition, users 102a-c are allowed to access and modify file system 112 on server 110 via file permissions native to file system 112. In particular, users 102a-c at least have permission to read and modify the directory in which chat file 114 resides. Thus, users 102a-c, from their remote locations, use clients 104a-c to communicate with one another by clients 104a-c connecting to server 110 and writing messages to chat file 114 stored within file system 112. Clients 104a-c (in this example, the computer, the laptop, and the PDA) also read the changes made to chat file 114 by the other clients 104a-c and notify users 102a-c of the changes. The type of interaction between users 102a-c and their clients 104a-c may differ between each other. In this example, users 102a-b each use a keyboard and monitor to interact with clients 104a-b. However, user 102c orally communicates with client 104c, the PDA, by using a microphone and headphones connected to her PDA. User 102c speaks the messages she would like users 102a-b to receive, and client 104c translates that information into text information and posts it to chat file 114 residing on server 110. In addition, user 102c listens to client 104c, the PDA, as client 104c reads to her the changes made to chat file 114 residing on server 110. Thus, an example has been described of how users 102a-c communicate with one another by utilizing clients 104a-c to access chat file 114 stored on server 110 within file system 112.

In one embodiment, client 104 is a computer. Alternatively, client 104 may be representative of a cellular telephone, an electronic notebook, a laptop, a PDA, or any other suitable device or software configured to enable interaction between users 102 and server 110 through network 108.

Network 108 is a communicative platform operable to exchange data or information emanating from user 102. Network 108 could include a plain old telephone system (POTS). Transmission of information emanating from the user may be assisted by management associated with server 110 or manually keyed into a telephone or other suitable electronic equipment. In some embodiments, network 108 could include any packet data network offering a communications interface or exchange between any two nodes in the file-based chat system. Network 108 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment, including a combination of any networks or systems described above. In various embodiments, connections 106 may include, but are not limited to, wired and/or wireless mediums which may be provisioned with routers and firewalls.

Server 110 may be any device which contains file system 112. This may include a computer, PDA, cellular telephone, electronic notebook, a laptop, or any other suitable device and/or software in which a file system may reside. In the embodiment depicted in FIG. 1, server 110 is a separate device than clients 104. However, in other embodiments, server 110 may actually be the same device as one or more of the clients 104. For example, user 102a may have chat file 114 residing in his personal computer; this computer may also serve as client 104a. Thus, the other users 102 may connect to this computer, which is server 110 since it is the device that contains chat file 114. The ability to flexibly establish a file-based chat is advantageous. There is a reduction of dependence on a central server since the chat file may reside in any system that allows for remote access to a file system. So, as an example only, if a central server were to malfunction, communication would not have to be discontinued until the server was repaired: instead, clients may connect to another chat file residing, for example, on another server and continue to communicate. Another benefit present in certain embodiments of file-based chat is the ability to work across different platforms. Such embodiments may have different platforms running on each client 104 and on server 110. For example, the server 110 may be running on a Unix-type operating system, while the clients 104 may be running a version of Windows or Mac OS X. This cross-platform compatibility facilitates deployment of the chat in certain embodiments.

File system 112 comprises chat file 114. Access to chat file 114 is governed by permissions native to file system 112. In one embodiment, the native permissions of file system 112 may be configured to grant at least read access and/or write access to selected users to chat file 114. In other embodiments, the native permissions of file system 112 may be configured to grant read and/or write access to chat file 114 to selected groups of users. File system 112 may comprise disk file systems (such as FAT, NTFS, HFS and HFS+, ext2, ext3, ISO 9660, ODS-5, and UDF), flash file systems (such as JFFS2 and YAFFS), database file systems (such as dbf s), journaling file systems (such as XFS and UFS), and network file systems (such as NFS, AFS, and SMB). The wide scope of possible embodiments for file system 112 is advantageous in that it facilitates the implementation of a file-based chat since it may be easily deployed within an existing framework.

Consider, as an example only, a situation in which a file-based chat is to be deployed in a topology as illustrated in FIG. 1. File system 112 is implemented using the ext3 file system. The ext3 file system contains native permissions which allow at least read and write access to be configured on a per user, per group, and per owner basis. Continuing the example, assume users 102a-c are to participate in the chat. In this situation, the permissions native to file system 112 would be configured to allow read and write access to chat file 114 by users 102a-c. However, assume that user 102b should no longer be allowed to participate in the chat. This may be implemented by configuring the permissions native to file system 112 such that user 102b neither has read nor write permissions to chat file 114. In another example, assume that user 102a should only be able to read the contents of the chat, but should not be able to post messages to the chat while users 102b-c should be able to read and post messages to the chat. In this scenario, permissions native to file system 112 would be configured such that user 102a only has read access to chat file 114 while users 102b-c have read and write access to chat file 114.

A variety of protocols may be used by clients 104 to access chat file 114. As described further below, clients 104 only need to be able to read from and write to chat file 114 to communicate with other clients 104. Thus, a large variety of protocols may be used to facilitate this access. Further, multiple protocols may be used together to facilitate access to chat file 114. In addition, each client 104 may use a different protocol to access chat file 114. For example, assume users 102a-c are connected to chat file 114. User 102a uses the file transfer protocol (FTP) to access and modify chat file 114. But user 102b, in this example, uses the secure shell protocol (SSH) to access and modify chat file 114. Finally, user 102c uses a virtual private network (VPN) to connect to chat file 114. This flexibility in protocol provides an advantage in that chat communication may occur through existing security frameworks. Security policies do not need to be refactored to account for the need for chat communication since many security policies already provide remote access to a file system.

FIG. 2 illustrates a screenshot of a client displaying the content of a chat and a chat file in accordance with a particular embodiment. Chat file 202 is the file to which users write and read. It comprises timestamp 206, user identification 204, and message 212. Client 214 accesses and modifies chat file 202. Client 214 comprises chat display area 208 and text area 210. In some embodiments, chat file 202 is a plain text file. In other embodiments, chat file 202 is structured using a markup language, such as XML or HTML. In one embodiment, a user would interact with client 214 to both read and post messages. Chat display area 208 is where client 214 displays the contents of the chat to a user. When a user wants to post a message, the user enters the message in text area 210. The user then instructs client 214 to post the message. As described in more detail below, client 214 will modify chat file 202 with the message. As an example only, client 214 will add timestamp 206, user identification 204, and message 212 to chat file 202. Other clients will then read chat file 202 and display this newly appended information to their associated users.

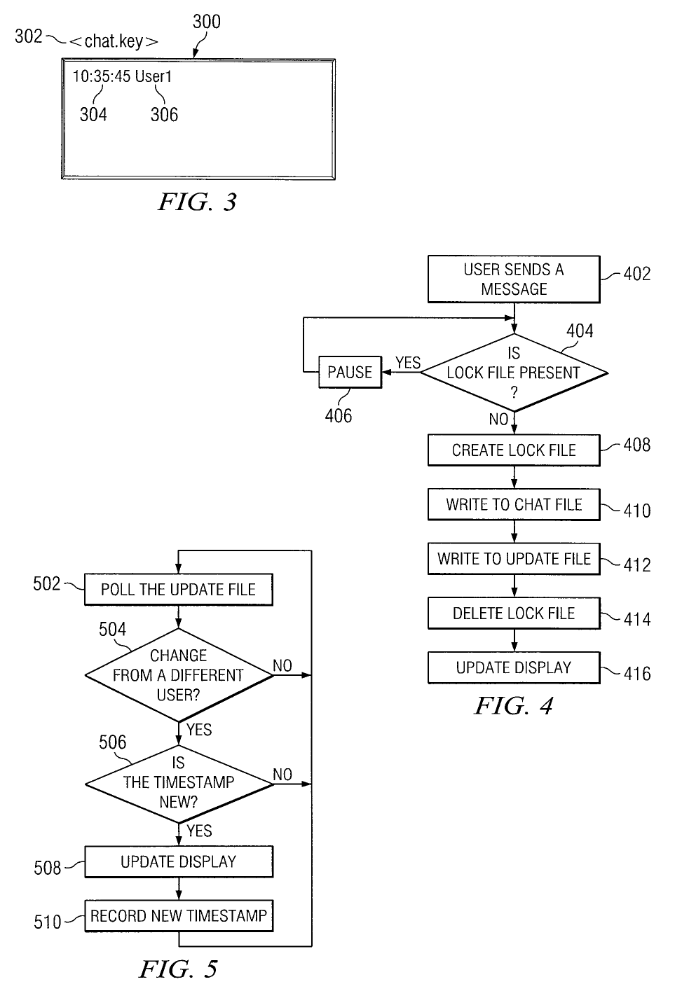

FIG. 3 illustrates one embodiment of update file 300. Update file 300 comprises file name 302, timestamp 304, and user identification 306. Update file 300 resides in the same directory as the chat file. Timestamp 304 and user identification 306 correspond to the last time an entity wrote to the chat file. As an example only, consider a situation in which a user would like to post a message to the chat. In this example, once the user's client has written the message to the chat file, the client would then update chat file 300 replacing its contents with timestamp 304 and user ID 306 which corresponds to the time at which the message was posted to the chat and the user who posted that message.

As an example only, consider update file 300 as depicted in FIG. 3. Timestamp 304 reads 10:35 with 45 seconds, and user identification 306 reads User1. A client will read update file 300 and determine based on its contents whether or not the client's screen needs to be updated. In one example, the client will compare user identification 306 to the user identification associated with the client. If user identification 306 is the same as the user identification associated with the client, the client will not update the screen (because this message has already been displayed to the user) and will continue to monitor update file 300 for any changes. However, if user identification 306 is different than the user identification associated with the client, the client will then examine timestamp 304. If timestamp 304 is different than the timestamp previously recorded, the client then knows that the chat file has been altered since it was last read by the client. As a result, in this example, the client will read the chat file and display the changes for the user associated with the client. In addition, the client will record a new timestamp so that it may later use it as a basis for comparison when it polls the update file again. However, if timestamp 304 is equivalent to the timestamp previously recorded by the client, the client will not read the chat file (because this shows that there have been no changes to the chat file since the client has last checked) and will monitor update file 300 for changes. In other embodiments, the information contained in update file 300 may be embedded into a special section of the chat file itself. In those embodiments, clients in the chat would read the special section of the chat file and find information similar to what has been discussed above.

FIG. 4 is a flowchart describing one embodiment of the manner by which a client may write to a chat file. In step 402, using the client, a user may type in a message and direct the client to post the message in the chat. In step 404, the client will check to see if a lock file is present. In one embodiment, a lock file is an empty file located in the same directory as the chat file. In other embodiments, the lock file may be a portion of the chat file itself. The lock file indicates to a client that a chat file is not available to be written to. This may be, for example, because another client is writing to the chat file. Step 406 is performed if a lock file is present; in step 406 the client will pause for a predetermined amount of time after which it will return to step 404 and check if the lock file remains present. In step 408, the client has determined that a lock file is not present and will create a lock file. In step 410, the client will modify the chat file with the message the user instructed the client to post. In step 412, the client will modify the update file with the user's identification and the current time. In step 414, the client will delete the lock file, thereby allowing other clients to write to the chat file. In step 416, the client will update its display with the message posted to the chat.

In some embodiments, a log of the conversation which occurred in the chat may be created by using the chat file. As described above, messages may be posted to the chat by writing the messages into the chat file. Thus, a log may be created by, in some embodiments, copying the contents of the chat file into a log file. In particular embodiments, the log file may be saved to a different location. The log file may also be archived for, in certain embodiments, purposes such as meeting minutes, security logs, accountability reviews, etc.

In various embodiments, a log of the conversation may also be created by examining portions of the chat file. As described above, messages may be posted to the chat by writing the messages into the chat file. A log of any portion of the conversation may be created by examining the portion of the chat file which contains the relevant portion of the conversation. In some embodiments, a copy of the examined portion of the chat file may be saved into a log file. In particular embodiments, logs may be generated in real-time by merely examining the relevant portion of the chat file without creating a copy of a part of the chat file. In certain embodiments, timestamps present in the chat file, such as timestamp 206 depicted in FIG. 2, may be utilized to identify the relevant portion of the chat file.

FIG. 5 is a flowchart describing one embodiment of how a client will update its display. In step 502, the client polls the update file, reading its contents. In step 504, the client will determine whether a change has been made to the chat file by a user different than the user associated with the client. If the user identification in the update file correlates to the user with which the client is associated, then the client will return to step 502 and poll the update file. If the user identification in the update file is different than the user associated with the client, then the client examines the timestamp in the update file in step 506. If the timestamp is the same as one previously recorded by the client, the client returns to step 502 and polls the update file. If the timestamp is different than the one previously recorded, the client enters step 508 where it updates its display by reading the chat file and displaying the messages on its display. This will include new messages added since the last update. In step 510, the client records the timestamp from the update file and then returns to step 502 where it polls the update file.

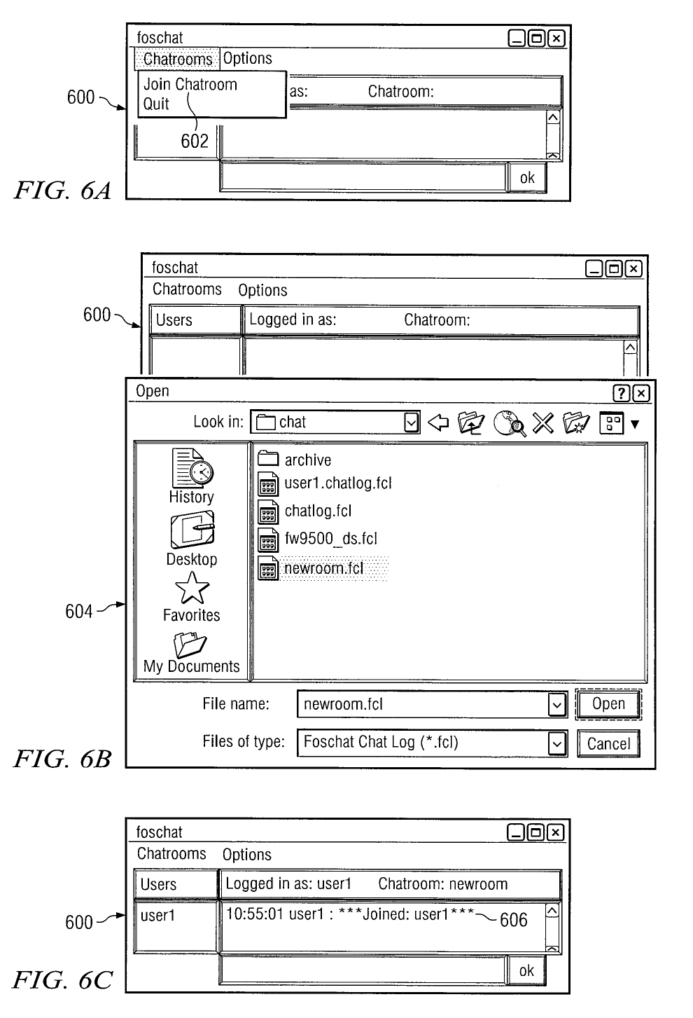

FIGS. 6A, 6B, and 6C illustrate screenshots depicting the manner by which a user may join a chat in accordance with a particular embodiment. FIG. 6A depicts one embodiment of the interface that client 600 provides to the user; it comprises join button 602. The user may operate join button 602 to indicate to client 600 that the user would like to join a chat. FIG. 6B illustrates client 600 responding to the operation of join button 602 by presenting to the user file dialog 604. From file dialog 604 the user may navigate to and choose the chat which it would like to join. FIG. 6C illustrates client 600 responding to the user selecting a chat to join from file dialog 604. Client 600 enters the chat and posts a message to the chat indicating that the user has joined the chat. One example of such a message is welcome message 606.

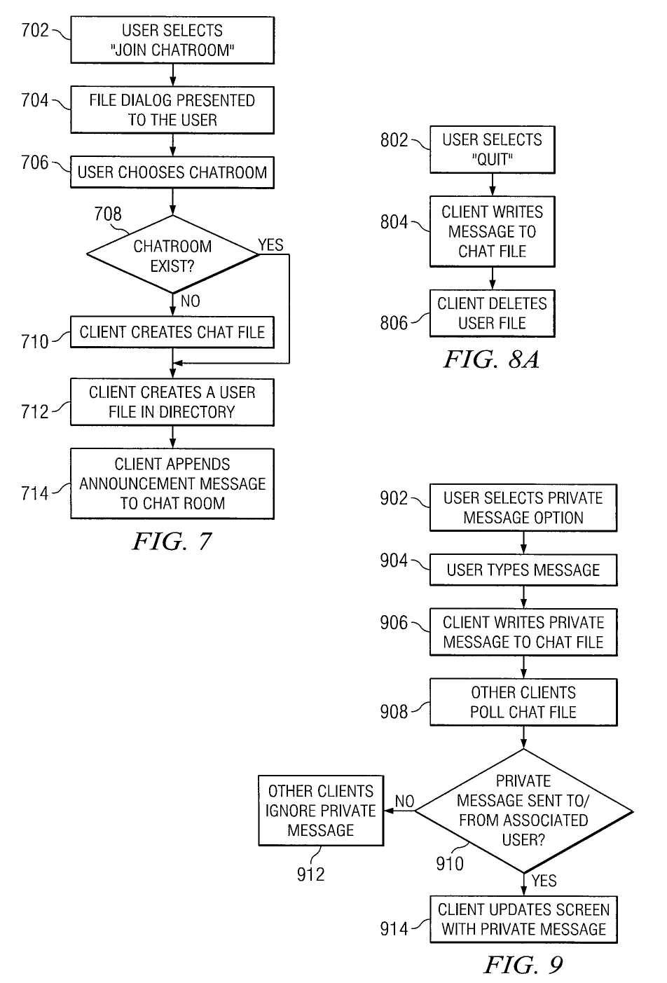

FIG. 7 is a flowchart describing one embodiment of the manner by which a user may join a chat. In step 702, the user instructs the client (through the interface) that it desires to join a chat. In step 704, the client presents a dialog to the user allowing the user to specify the chat the user wishes to join. In step 706, the user indicates to the client which chat the user would like to join through the interface provided by the client. This may include the selection to a start a new chat not currently in existence. In step 708, the client checks to see if the chat chosen by the user exists. If it does not exist, the client creates the chat file (step 710) in the location specified by the user through the interface; the client proceeds to step 712. If the chat chosen by the user does exist, the client proceeds to step 712 and creates a user file in the same directory in which the chat file is located. A user file indicates the presence of a user in the chat. In one embodiment a user file is an empty file with a file name that contains a user identifier. In another embodiment, the user file is located within the chat file. In yet another embodiment, the user file is contained in a file which has a list of users associated with the chat. In still other embodiments, the user file may contain information about the user such as the user's profile which may include the user's name, location, and contact information among other items. In step 714, the client appends a message in the chat indicating that the user has joined the chat.

In various embodiments, clients may determine which users are in the chat by utilizing the user file described above. In some embodiments, when a client reads a message in the chat indicating that a user has joined the chat, the client will examine the directory in which the chat file exists for user files. The client may then create a list of users in the chat based on the associated user files found in the directory.

In certain embodiments, a chat file may include the user files within it, as described above. A client, while polling the chat file for new messages, may also poll the user files stored within the chat file to determine which users are present in the chat. In some embodiments, a client may utilize a timestamp within the chat file associated with the user files stored in the chat file; in one example, if the timestamp in the chat file associated with the user files is newer than a timestamp recorded previously (or if the client has not previously recorded a timestamp associated with the user files), the client will examine the user files to determine which users are in the chat. If the timestamp is the same as one that the client has previously recorded, the client will not examine the user files.

Certain embodiments may provide the benefit of flexibly adding chats that others may join. As described above, users may direct their clients to create a chat if one does not already exist. Central administration is not needed to create the new chats. This provides rapid and efficient deployment of communications that can be tailored to the situation.

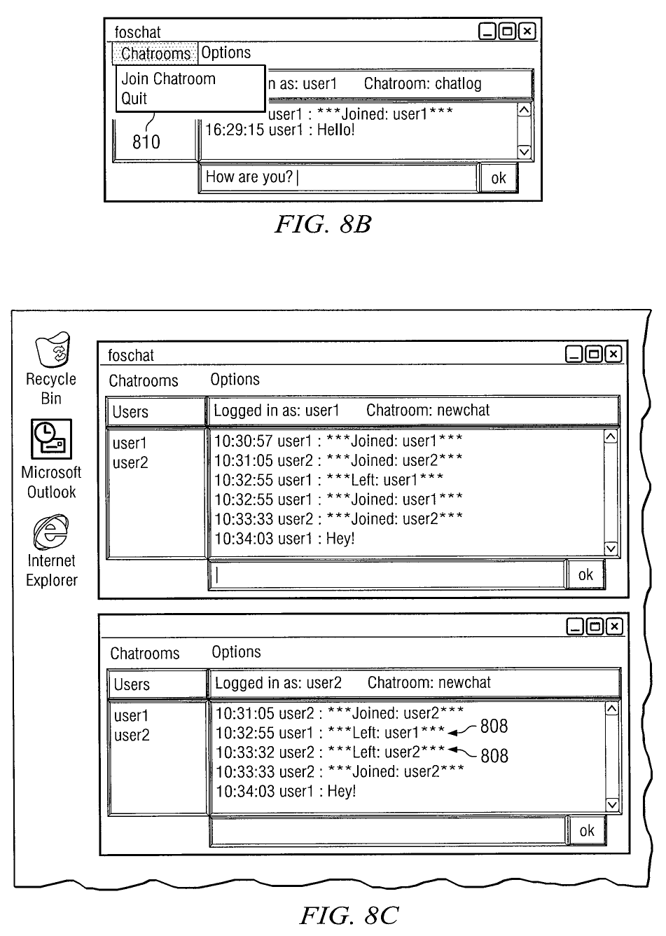

FIG. 8A is a flowchart describing one embodiment of the manner by which a user may leave a chat. In step 802, the user indicates to the client that it desires to leave the chat. In step 804, the client appends a message to the chat indicating that the user has left the chat. In step 806, the client deletes the user file associated with the user.

FIGS. 8B and 8C illustrate screenshots depicting the manner by which a user may leave a chat in accordance with a particular embodiment. In FIG. 8B the user may instruct the client that it wishes to leave the chat by using quit button 810. In response the client will indicate in the chat that the user has left the chat. One example of this can be seen in FIG. 8C in which departure message 808 is appended to the chat by the client.

FIG. 9 is a flowchart describing one embodiment the manner by which a user may send a private message to another user in the chat. In step 902 user indicates to its associated client that it desires to send a private message to another user in the chat. A private message is designated to be read only by one other user through that user's client. In step 904, the user types the private message. Step 906 involves the client posting the message to the chat file, but indicating that the message is private as well as indicating to whom the message was sent. In step 908, the other clients in the chat read the chat file and notice the new private message. These other clients, in step 910, determine if the private message was sent to their associated user. If it was not, the other clients proceed to step 912 where they disregard the message. Thus, their displays are not updated. If one of the other clients is associated with the user to whom the private message was sent, that client will proceed to step 914 where it updates the display with the private message, indicating that the message was a private message. Therefore, in this embodiment, only the client associated with the sender of the private message and the client associated with the recipient of the private message will update their displays.

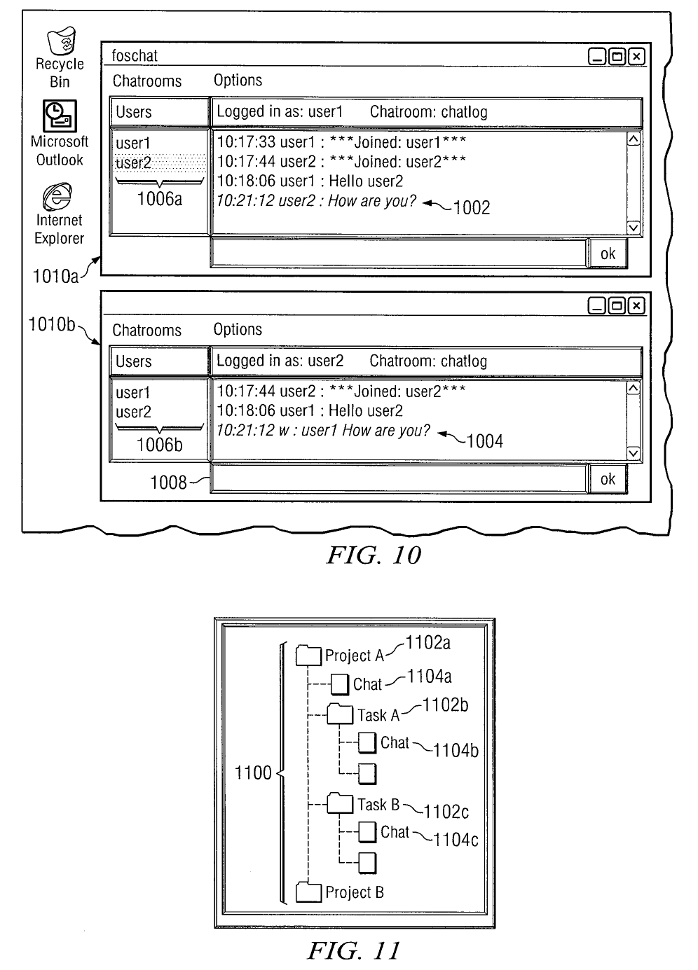

FIG. 10 illustrates a screenshot depicting the manner by which one user in the chat sends a private message to another user in the chat in accordance with a particular embodiment. In this embodiment, client 1010a is associated with a first user and client 1010b is associated with a second user. Client 1010a comprises user list 1006a and received private message 1002. Client 1010b comprises user list 1006b, sent private message 1004, and text input field 1008. User lists 1006a-b are lists which indicate who is present in the chat. By using user list 1006b the second user may indicate to client 1010b to whom a private message should be sent. Assume, as an example only, the second user selects the first user. After selecting the recipient of the private message, the second user may then use text input field 1008 to enter the private message. The second user may then indicate to client 1010b to send the private message. In response, client 1010b displays to the second user the private message the second user sent. An example of this is sent private message 1004. Once client 1010a has read the chat file, client 1010a will display the private message to the first user. One example of this is received private message 1002. Neither sent private message 1004 nor received private message 1002 will display on any other client.

FIG. 11 illustrates a directory structure throughout which chat files may be dispersed. Directory structure 1100 comprises folders 1102a-c and chat files 1104a-c. In particular embodiments, chat files may be organized within a project's directory structure allowing for a natural workflow. In some embodiments, a workflow may include the manner, processes, and/or tasks through which a project is to be accomplished. As an example only, consider a situation in which an organization is attempting to accomplish a project, Project A. Further, consider that this project can be broken down into a set of tasks, Tasks A and B. Folders 1102a-c are one embodiment of how directory structure 1100 may look in this situation. Chat files 1104a-c are disbursed throughout directory structure 1100 such that each folder 1102 has a chat file 1104. Thus, in this example, if the team of people working on Project A would like to discuss issues relating to the overall project, they would use chat file 1104a in folder 1102a which is associated with Project A. Further, if a team of people would like to communicate about Task A, they would use chat file 1104b located in Task A folder 1102b. Hence, communications are automatically organized into the organization's existing workflow. This is advantageous in that if someone would like to reexamine the communications about, for example, Task B, they would not need to sort through all of the communications regarding Project A. Instead, they would simply examine chat file 1104c located in folder 1102c to find communications about Task B.

Disbursing chat files in this manner also allows for mass communication. This may occur by a client traversing the directories and posting a message in each of the chat files. Consider an example of an organization with seven people working on Project A. During the course of the day, three of the team members are in the chat associated with Task A, while two other team members are in the chat associated with Task B. The last two members of the team are in the chat associated with Project A. One of the members in the Project A chat decides that all of the team members should gather for a meeting in a conference room. This team member then directs his client to broadcast such a message. The client will then post a message in the current chat and will traverse the directories and post a message in each of the chats found. So, in this example, the client first posts the message in the Project A chat, which is within folder 1102a. Then, the client moves to folder 1102b (in this example, for Task A), and posts in chat file 1104b. Continuing this example, the client moves to folder 1102c (for Task B) and posts in chat file 1104c. Hence, though the team members have been disbursed in chats across a directory structure, all members may be communicated with simultaneously.

Establishing secure chats may also be accomplished through the use of directories in the file system. As an example only, consider the illustration in FIG. 11. In this example, file system 1100 has been configured with a security policy such that only members of the team working on Project A can access and edit files in directories within the folder 1102a. So members of another project (such as Project B) would not be able to access or manipulate the files in Project A. This security policy will automatically apply to chat files 1104a-c. For example, consider chat file 1104a. In order to join the chat you must be able to at least read chat file 1104a. Thus, if a user is not a part of Project A and does not have permission to access folder 1102a, the user will also not have permission to access chat file 1104a associated with Project A. Continuing the example, members of Task B may not be able to access chat file 1104b associated with Task A. Again, this occurs through the manipulation of file permissions within the file system in which the directory structure is located.

Particular embodiments of a file-based chat system have been described. An advantage present in some embodiments is the ease in which the chats may be deployed. In addition, certain embodiments provide the benefit of cross-platform compatibility. Further, chats may be easily adapted to different applications, such as different workflows.

Although several embodiments have been illustrated and described in detail, it will be recognized that modifications and substitutions are possible without departing from the spirit and scope of the appended claims.

What is claimed is:

1. A method for computer-based chat, comprising:
coupling a plurality of clients to at least one chat file residing in a file system;
appending a first text from at least one of the plurality of clients to the at least one chat file; and
updating the plurality of clients with changes made to the at least one chat file.

2. The method of claim 1, further comprising allowing access to the at least one chat file via a set of file permissions native to the file system.

3. The method of claim 1 wherein the at least one chat file is a plain text file.

4. The method of claim 1 wherein the at least one chat file is created by at least one of the plurality of clients.

5. The method of claim 1 further comprising:
appending a second text from a first client of the plurality of clients to the at least one chat file, wherein the second text is designated only for a second client of the plurality of clients; and
updating only the first and second clients as a result of appending the second text to the at least one chat file.

6. The method of claim 1 further comprising creating a user file associated with a client when the client is coupled to the at least one chat file to indicate presence.

7. The method of claim 1 further comprising deleting a user file when one of the plurality of clients is decoupled from the at least one chat file.

8. The method of claim 1, wherein the at least one chat file consists of a plurality of chat files residing in a plurality of directories in the file system so that chats may be organized.

9. The method of claim 8, further comprising:
traversing the plurality of directories by at least one client of the plurality of clients;
coupling the at least one client to each of the plurality of chat files in the plurality of directories; and
appending at least one text from the at least one client to each of the plurality of chat files in the plurality of directories.

10. A system for computer-based chat, comprising:
a first interface of a first client of a plurality of clients, the first interface operable to couple the first client to at least one chat file residing in a file system; and
a first processor of the first client and coupled to the first interface, the first processor operable to:
append a first text from the first client to the at least one chat file; and
update a first display of the first client with changes made to the at least one chat file.

11. The system of claim 10, wherein the first processor is further operable to communicate through a set of file permissions native to the file system in order to access the at least one chat file

12. The system of claim 10, wherein the at least one chat file is a plain text file.

13. The system of claim 10 wherein the first processor is further operable to create the at least one chat file.

14. The system of claim 10 wherein the first processor is further operable to create a user file associated with the first client when the first client is coupled to the at least one chat file to indicate presence.

15. The system of claim 10, wherein the first processor is further operable to delete a user file when the first client is decoupled from the at least one chat file.

16. The system of claim 10, wherein the at least one chat file consists of a plurality of chat files residing in a plurality of directories in the file system so that chats may be organized.

17. The system of claim 16, wherein:
the first processor is further operable to traverse the plurality of directories;
the first interface is further operable to couple the first client to each of the plurality of chat files in the plurality of directories; and
the first processor is further operable to append at least one text from the first client to each of the plurality of chat files in the plurality of directories.

18. A method for computer based chat, comprising:
coupling a plurality of clients to at least one plain text file residing in a file system;
appending a first text from at least one of the plurality of clients to the at least one plain text file;
updating the plurality of clients with changes made to the at least one plain text file; and
allowing access to the at least one plain text file via a set of file permissions native to the file system.
